(19) United States
(12) Patent Application Publication
(10) Pub. No.: US 2006/0145433 A1
(43) Pub. Date: Jul. 6, 2006

(54) Running apparatus for stairs, ramps and off roads

(76) Inventor: Seo-Rim Kim, Daegu (KR)

Correspondence Address: PARK LAW FIRM, 3255 WILSHIRE BLVD, SUITE 1110, LOS ANGELES, CA, 90010, US

(21) Appl. No.: 10/541,923

(22) PCT Filed: Dec. 30, 2003
(86) PCT No.: PCT/KR03/02924

§ 371 Date: Mar. 9, 2006

(30) Foreign Application Priority Data
Jan. 9, 2003 (KR) 1020030001394

(51) Int. Cl. B62B 9/02; B62D 61/10

(52) U.S. Cl. 280/5.28; 280/149.2; 180/24; 180/24.01

(57) ABSTRACT

This running apparatus(1) has 4 wheels(3) operating seesaw type are axle installed on the first and second lever(4.5.6). This running apparatus can travel with its 8 wheels or sometimes 4 wheels touching grounds at any circumstances. This is very suitable for the wheel chair or truck carrying special cargo running on the stairs, ramps, sands, marshy muds, rocks, and so on. And comfortability and safety of this vehicle can be maximized by the seesaw movement of the first and second levers(4.5,6,) which diminish the shock according to the ground. When converting the second levers(5) of the front wheels which can axis operates according to the ground, with rack(11) and pinion(10) make one of front two wheels contact grounds and easily convert the steering wheel(16), and also possible to change the length and width of the vehicle cope with location and speed, and can travel with all good conditions

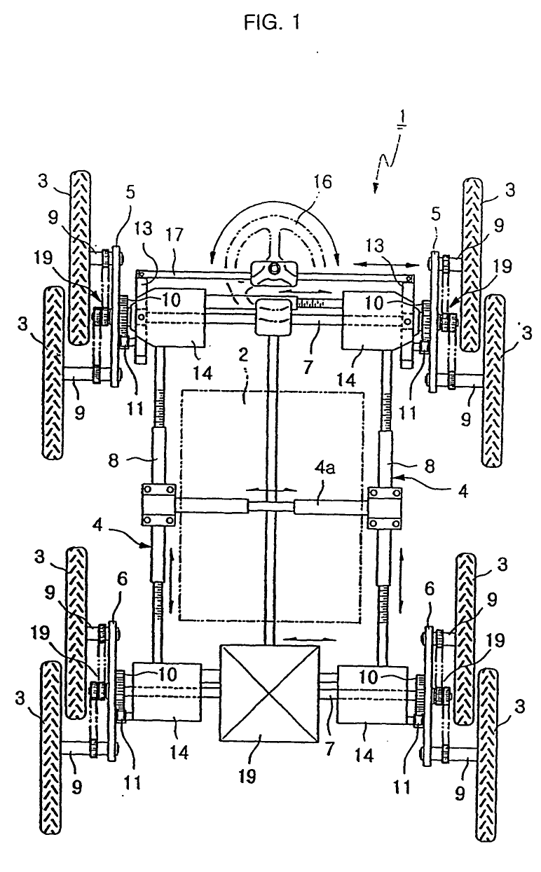

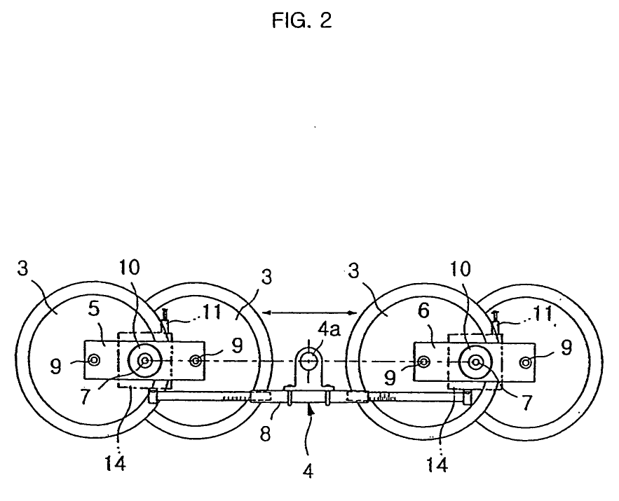

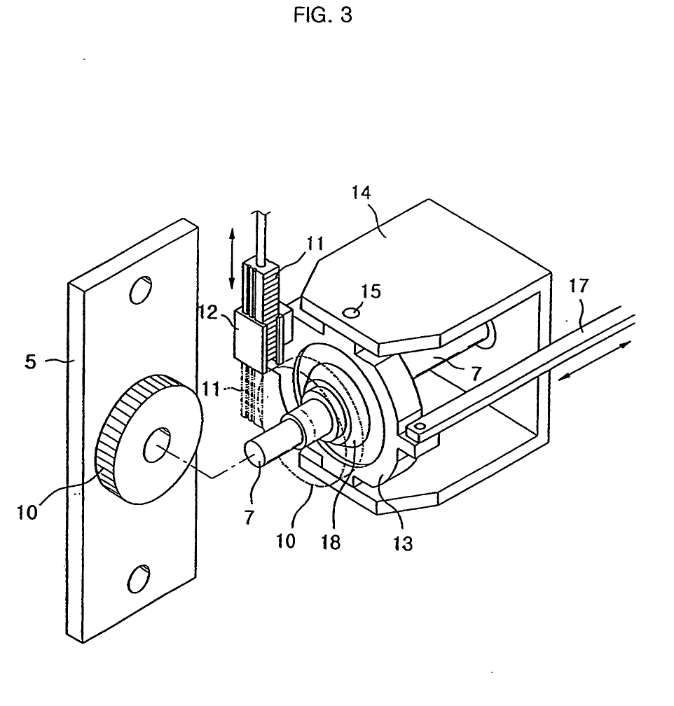

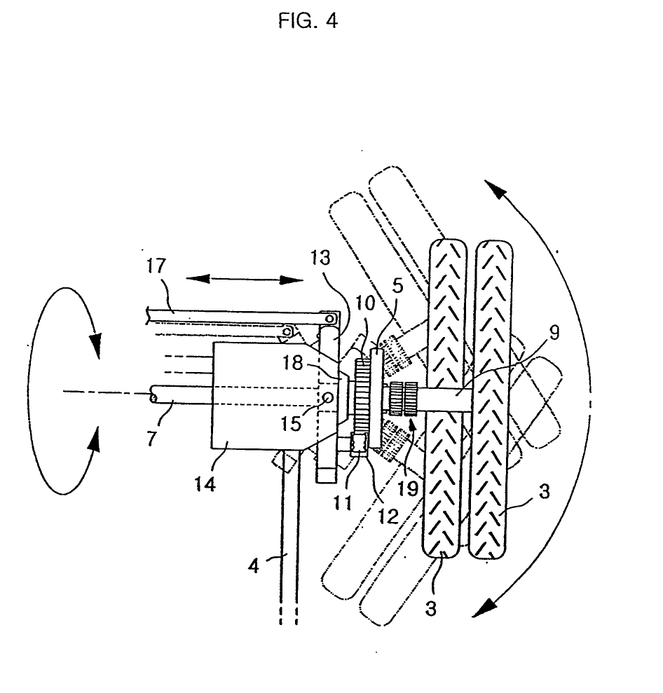

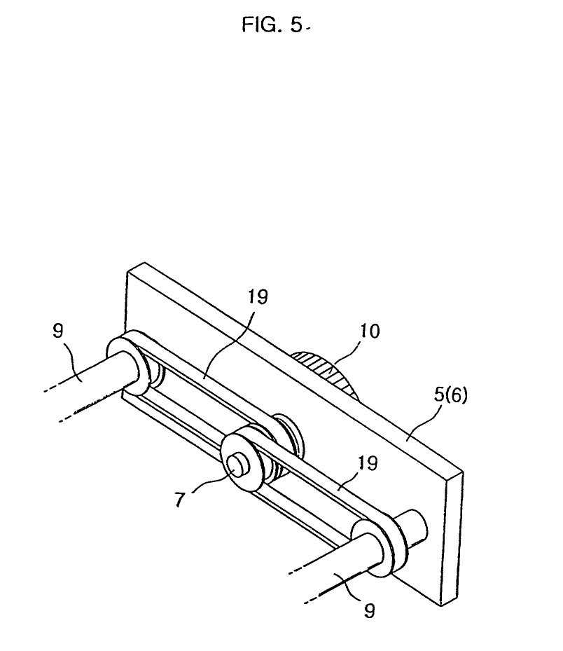

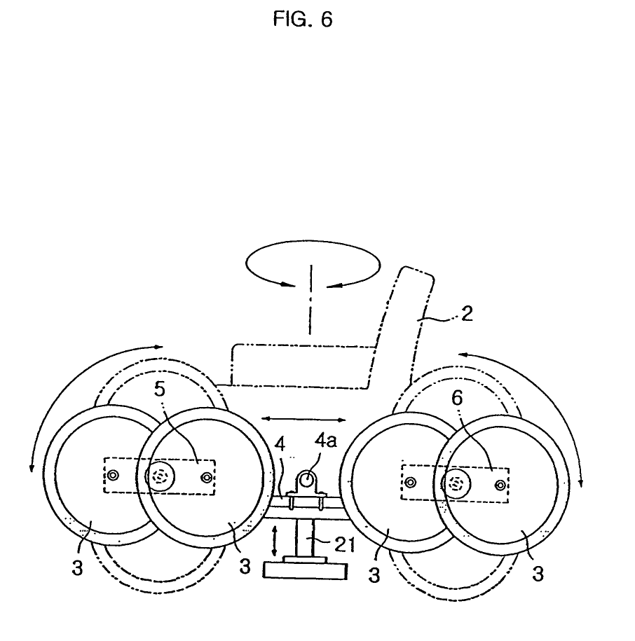

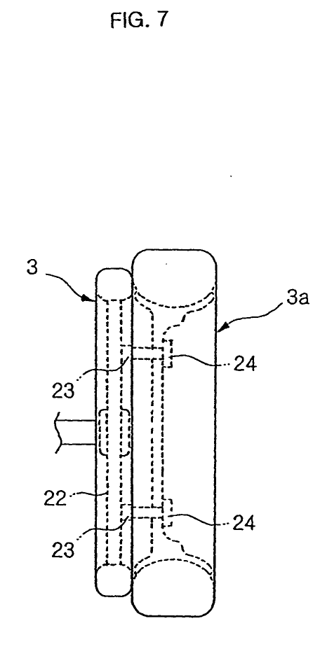

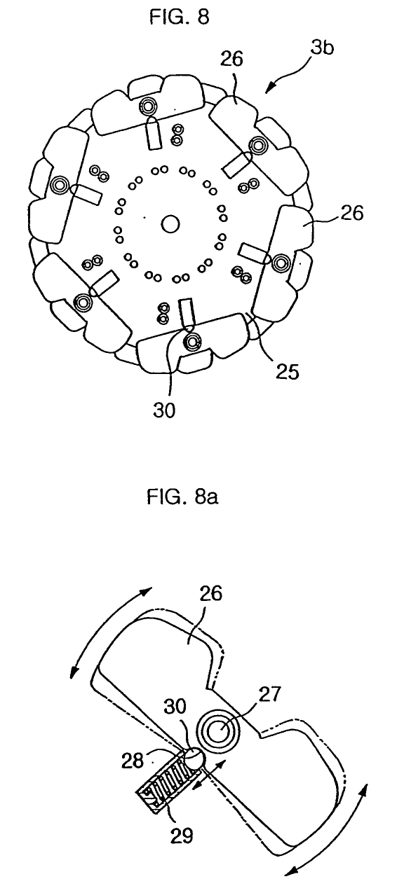

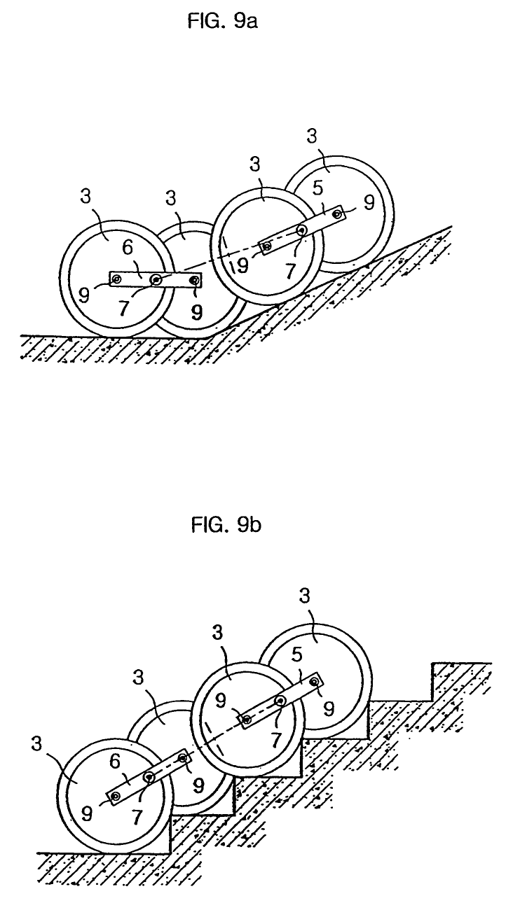

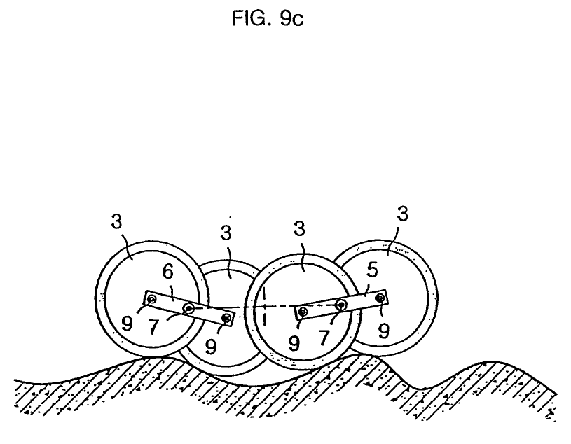

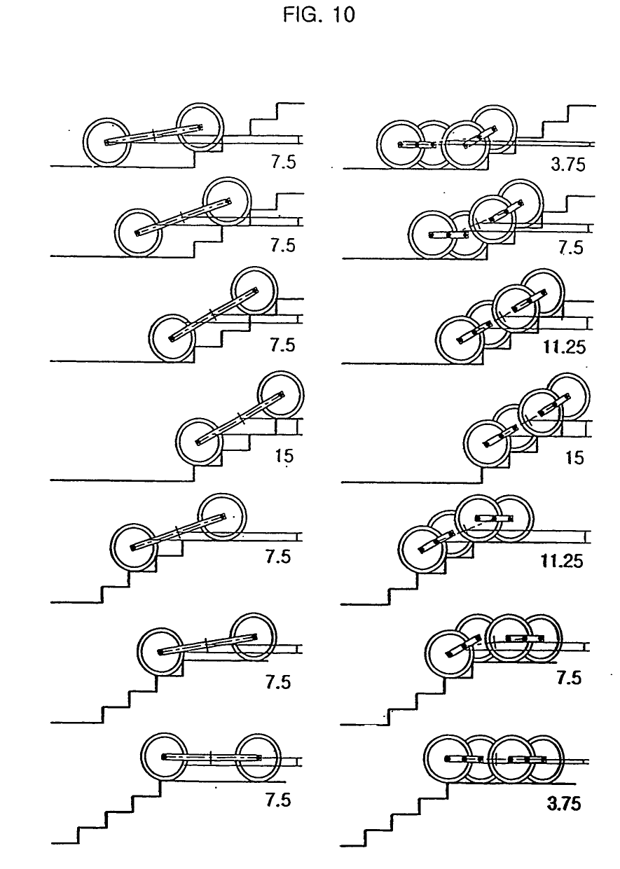

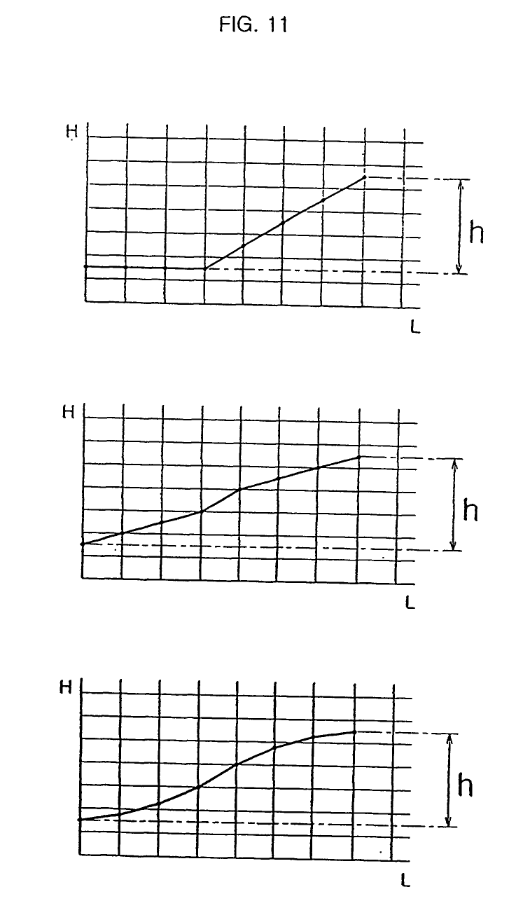

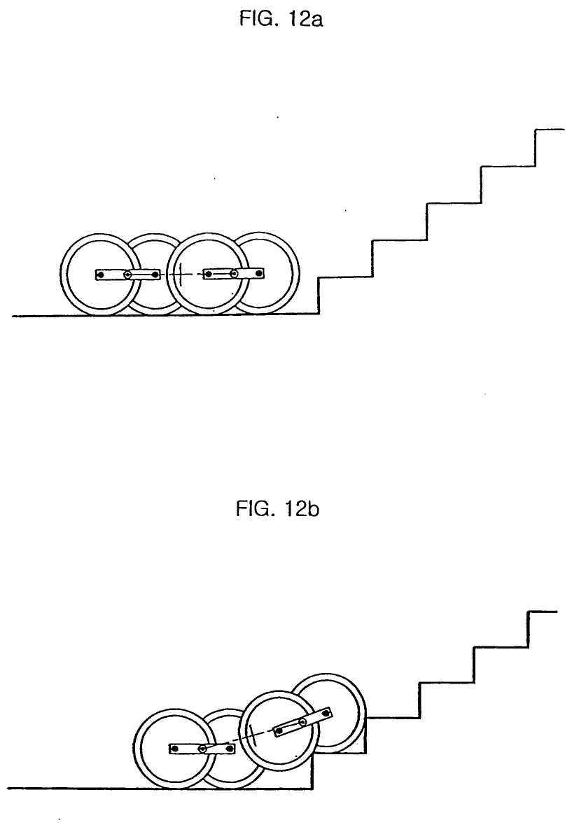

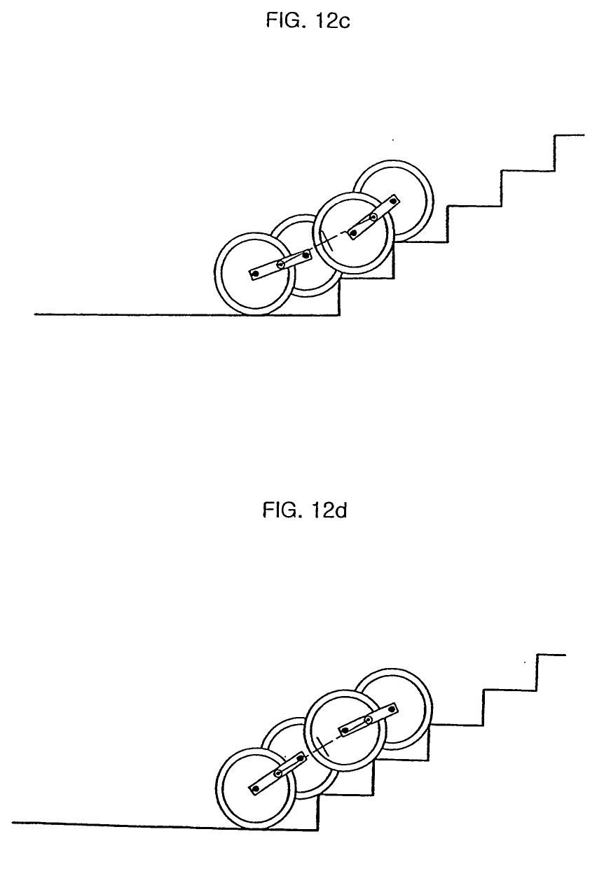

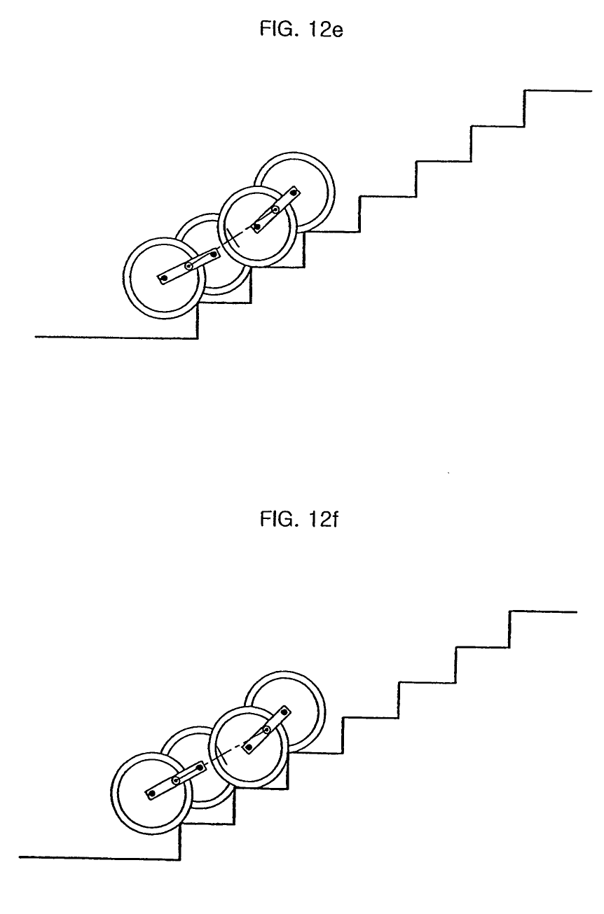

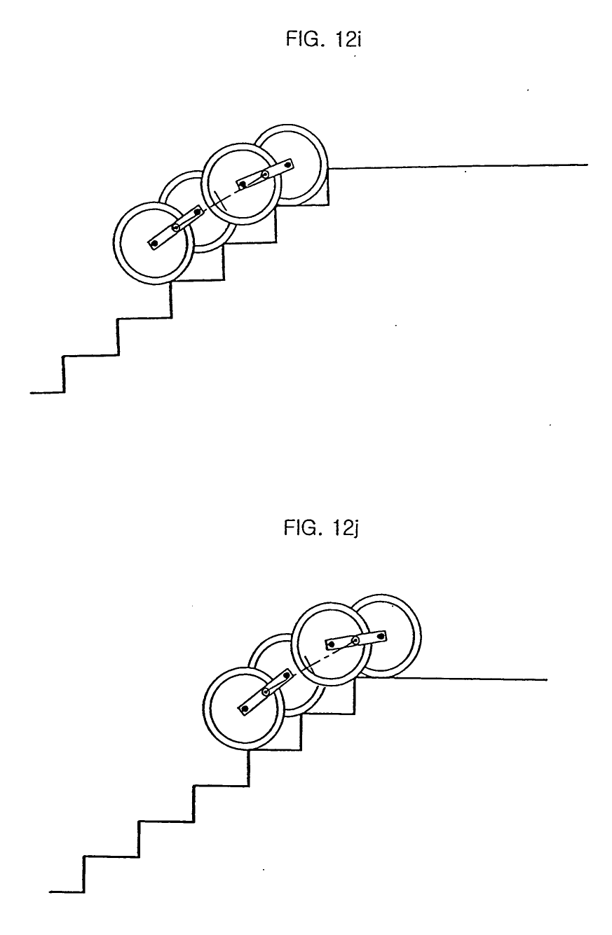

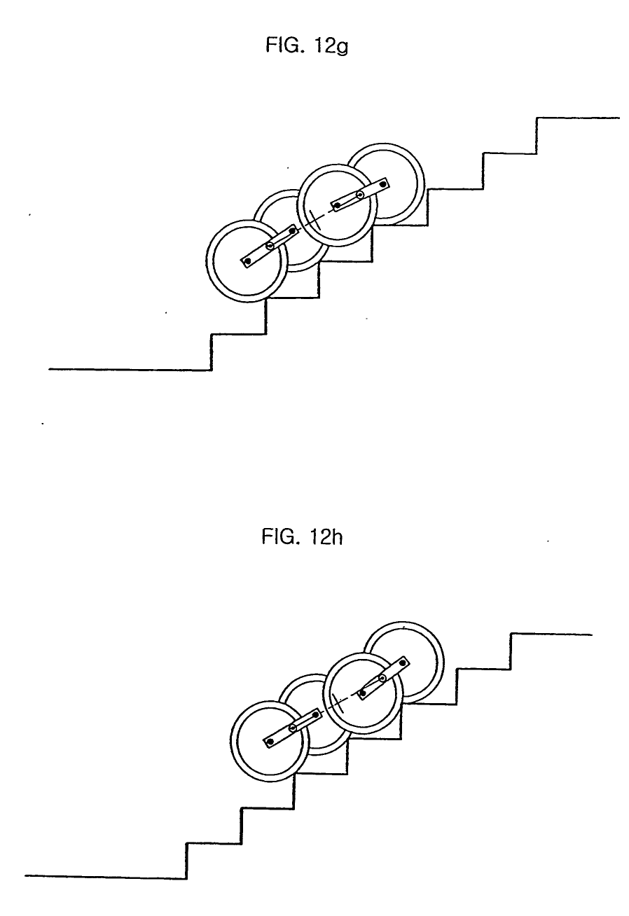

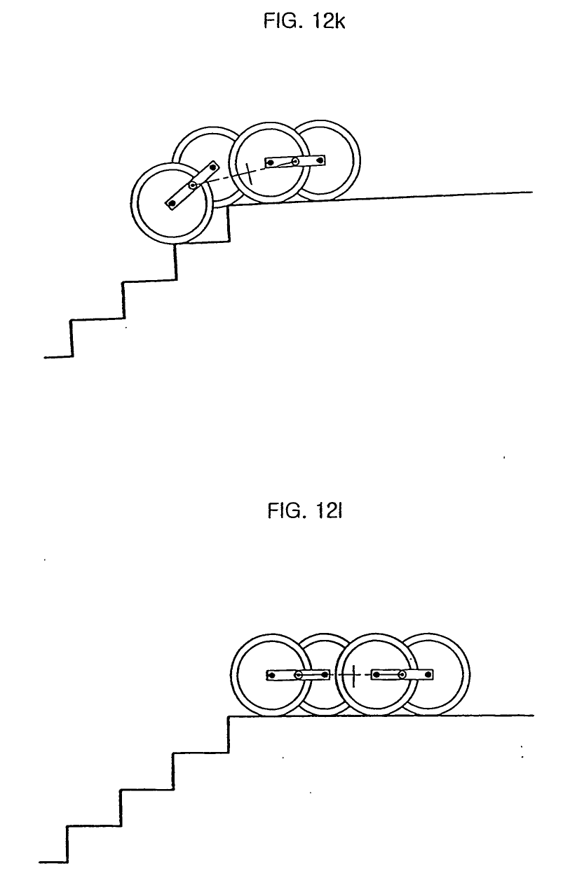

### TECHNICAL FIELD

This invention is about running apparatus which can travel on the stairs, ramps, and off road. One of the goals of this invention are for the crippled, this running apparatus can give them absolute no inconveniences to lead any social lives. Another is to move any cargos on any kind of roads.

This invention is about running apparatus installed on the transport which can travel on the stairs, ramps, and off road. the first levers(4) installed in the center of transport to be axis(4a) operated, the second levers(5,6) axis installed at the edges of the first lever(4) to be angle operated, wheels (3, 3b) installed at the edges of the second levers and connected to gearing device, The second levers(5,6) where pinion(10) fixed, rack guide(12) on the holder frame(14) where axis connected to generator and optionally connects to rack(11) and axis operates. The axis(7) where the second levers(5) axis installed, is set on the center of joint(18), and installed to be axis operated with pin(15) on the holder frame(14). And connection lever(17) and steering wheel(16) and connected knuckle(13) are connected and a driver can convert the direction.

This invention is about running apparatus which can travel on the stairs, ramps, and off road. One of the goals of this invention are for the crippled, this running apparatus can give them absolute no inconveniences to lead any social lives. Another is to make a running apparatus being capable of travelling with special cargo and applicable to wheel chair or truck.

In fact a disabled person who can not walk can move by wheel chair. But the problem is, the existing wheel chair can not travel on boundary between driveway and footway, stairs, ramps, off roads, therefore they movement should have a certain limit in every respects.

The average travelling speed of existing wheel chairs on the normal way is about 0-20 km/hour. The crippled can not commute or travel middle or long distances. In case they use the public transportation, they can't use without other person's help.

Tanks using caterpillar can climb ramps up to only 47° have difficulties passing by cliffs. For cargo, there were no running apparatus which can travel cliffs and very rough roads, they have had a lot of troubles in cargo transportation.

### DISCLOSURE OF INVENTION

The goal of this invention is to provide a running apparatus both which can solve the structural problem of wheel chair limiting the crippled moving, and which can move any cargo on any rough roads.

This running apparatus with 4 wheels on the both sides, totally 8 wheels set on the first and second seesaw type lever, under any circumstances, can minimize the shock on the rough roads by the touch of all wheels to the ground. This can remove almost all shocks transmitted from the stairs to the wheel chair. Not only low speed travelling also high speed travelling are possible.

A drive of this vehicle can replace wide wheels or caterpillar wheels so that she/he can travel on the sands, muds, or even rocks. To provide a new running apparatus can travel ramps maximum 62° is one of this invention's technical assignment.

8 wheels or 4 wheel(4) of the running apparatus with 4 wheels on the both sides, totally 8 wheels set on the first and second seesaw type lever(4, 5, 6), connect ground to travel, and this can be used as wheel chair for the crippled or a transport on the rough roads such as stairs, cliffs, sands, marshy grounds, rocks.

While travelling, shocks of each wheels can be minimized by the first and second seesaw lever can also maximize safety and comfort ability of the vehicle.

To convert the second lever(5) of the front wheel acting according to the surface to the direction to go, contacts one of two wheels(3) on the road with rack and pinion and simply convert by steering wheel.

One of advantages is to verify the width or length of vehicle under the condition of location or travelling speed, This ensures the best travelling condition and safety for the driver.

### BRIEF DESCRIPTION OF THE DRAWINGS

Drawing 1, Plane layout of structure of this invention

Drawing 2, Plane figure of seesaw type lever and wheels, the key point of this invention

Drawing 3, The principal part, steering dismantled figure

Drawing 4, The principal part, plane figure of steering operation

Drawing 5. A figure of wheel operation device

Drawing 6. The plane figure of wheels lifted by wheel operation lift

Drawing 7. The cross-sectional view of wheels attached with additional wide wheels

Drawing 8, The plane figure of caterpillar attached by the transport

Drawing 8a, The plane figure of caterpillar, one of principal parts of this invention

Drawing 9a or 9c, The plane figure of operating wheels according to the various roads

Drawing 10, The plane figure of height difference of center axis of this invention and the existing vehicle on upstairs

Drawing 11, Graph shows center inclination difference between this invention and the existing vehicle of front wheels or rear wheels according to the inclination of stairs

Drawing 12a/121, Simulation of steps of movement of this invention on upstairs

### EXPLANATIONS OF SIGN USED IN THE DRAWINGS

| | |
|---|---|
| 1: running apparatus | 2: transport |
| 3: 3a, 3b: wheel | 4: the first lever |
| 4a: axis | 5, 6: the second lever |
| 7: axis | 8: control device |
| 9: axis | 10: pinion |
| 11: rack | 12: rack guide |
| 13: knuckle | 14: hold frame |
| 15: pin | 16: steering wheel |
| 17: connection lever | 18: joint |
| 19: gearing device | 20: vent |
| 21: lift | 22: wheel |
| 23, 24: attachment device | 25: wheel |
| 26: caterpillar | 27: pin |
| 28: Differential gearing | 29: spring |
| 30: ball | |

### BEST MODE FOR CARRYING OUT THE INVENTION

Drawing 1 is the Plane layout of the proper running apparatus, Drawing 2 is the plane figure of seesaw type lever and wheels, The details with these will be as follows, This running apparatus optionally installed on the wheel chairs or other transport can travel on the roads, stairs, ramps, and off roads without any troubles.

Two front wheels and two rear wheels in the four seesaw type levers two in front and two in back connects to another seesaw type lever installed on the transport(2). Wheels can contact any type of roads and can minimize the driving shocks.

To convert wheels on the seesaw type lever, one of front or rear wheels is to be operated by controlling the angle of seesaw type lever. And consists of various wheels which optional installed or replaced according to the circumstances of roads.

No need to explain generator or transmission being attached optionally of the running apparatus because this running apparatus is applicable to the existing electric motor, or car engine to be operated.

The followings are the characteristics and constitutions of part of this invention. Wheel chairs or other transport have four wheels on right and left totally 8 wheels, The center of the seesaw type first lever installed on the right left sides of a transport should be axis installed in order that the first lever can control the angles with the axis as a starting point.

The second levers(5,6) installed axis on the edges of the first two levers on its axis should also control the angles by seesaw type.

The first levers being able to convert the length of a transport can be connected by various control unit (8) such as rack and pinion, leadscrew, turning ball and turning pin by option.

Wheels are axis installed by the second levers(5,6), and the angles of these second levers should be controlled vertically and horizontally. With these, the running apparatus can change its direction, control its height according to the road condition, and use only 2 wheels located to the direction a transport would go.

The second levers are axis installed on bearings to be turned on axis (7), and a pinion is welded or bolted in the centers of the second levers and fixed. Then fix rack(11) on the knuckle(13) by using rack guide to be gear connected or gear disconnected.

In conclusion, the second levers(5,6) can axis operate only when a pinion and a rack are gear connected, if a rack goes up and gear disconnected they are freely revolved and the second levers(5,6) can do smooth seesaw operations.

The up down operation of rack to connect or disconnect rack to pinion is operated by hydraulic power or leadscrew mechanically operated, it gear connects to pinion and rotate the second levers(5,6) The knuckle(13) installed on the holder frames with up/down pins(15) fixed on the front of holder frames(14) at the edges of the first levers(4) connects to steering wheel to convert. The axis(7) to transmit power is connected to a joint(18) set on the knuckle can transmit power when convert directions.

The axis(9) where axis(7), wheels(3) delivering power which can be connected to engine, or motor are axis installed and can deliver its power with chain, chain sprocket, timing belt, timing belt pulley and so on . . .

This running apparatus to be a full wheel drive needs a different device which delivers power from the generator to the axle of front and rear wheels. And steering whee(16) and connection lever(7), and knuckle(13) are set in the direction where this running apparatus will go.

And rear wheels(3) should be set as the second levers(6) should horizontally and vertically angle changed. This angle changer is the same as the one of front wheels(3).

This running apparatus can adjust the length or width by leadscrew type or control ball and control pin and so on . . .

When adjusting the width of running apparatus(1), lifter(21) should be set operating hydraulic jack operated by hydraulic cylinder or mechanical jack.

The wheels for this running apparatus(1) can be wheels of deep tread, wide off, roads wheel, or caterpillar of tank. The detailed explanation on caterpillar type wheels(3b) will be later.

The wheels(3) of running apparatus is welded with nuts to be attached to another wheels in advance. In case that a drive wants to attach wide wheels(3a) the driver can do it with attachment device(24) such as fixing bolt or others.

Caterpillar wheels (3b) fixed by pins(27) on the metallic panel of outside wheels are on the ball(30) where springs installed. Therefore it can diminish driving shock and straighten the gripping.

Independent suspension can be optionally attached on the wheels(3) to minimize pitching, rolling or bouncing which occurs when a running apparatus(1) goes on stairs or off roads.

As previously mentioned, this invention is a running apparatus which can travel on ramps, stairs, and off roads (9a or 9c), The below is details.

This running apparatus(1) has four wheels at one side totally 8 wheels and they are on the first and second levers connected to be seesaw axis operated. Therefore it insures the best comfortability and keeps shocks delivered to a transport.

The shock of two wheels(3) axis installed on the second levers(5,6), the center of the second levers(5,6) is axis installed at the edges of the first lever(4), the shock of ground can be absorbed on the second levers(5,6) about half, and the second levers(5,6) of front and back, the rest half shock can be absorbed by the first levers (4) axis installed on the transport then the shock can be minimized and run.

The first and second levers(4,5,6) are installed and able to turn freely, so the wheels of both edges of second lever(5,6) can seesaw operation on its axis, and the first levers(4) can also left and right (this, front back) can seesaw operation on its axis.

This running apparatus as drawing 10, and 11 can go up stairs very smoothly uncomparatively the existing front drive vehicles or mono drive vehicles.

That is, as drawing 10, the height of one stair is 15 cm. when a transport goes up one stair out of four stairs, the center of lever of the front drive or rear drive vehicle (left in the drawing) goes up about 7.5 cm which is about 7.5 cm. But this running apparatus, the center of the first lever goes up about 3.75 cm half of former one by the first and second levers. After that, from the second stair to the last stair, the center movement is regular, about 3.75 cm. from on the stairs to the ground the center movement is repeatedly smooth. Therefore the travelling on the stairs is very smooth.

In conclusion, Drawing 11, the existing transport having the existing wheels have big shocks when travelling stairs which height is “h” since the center movement is big. But this invention can have very smooth center movement which diminishes the difference of center movement.

As simulated in drawing 12a, 12i, when this running. apparatus goes up, the height of transport is a little bit lower than the existing transports from the point it starts to go onto stairs and escapes from the stairs. When four wheels(3) are all on the stairs, they are almost a line according to the angle of stairs in the drawing 12e to 12i. the shock from the stairs can be minimized. To be minimize the shock, it is desirable to make the distance between front wheel axis and rear wheel axis different.

Drawing 12a or 12i, width of one stair is 300 mm, and the height is 200 mm, the distance between axle of front wheels is 280 mm, the distance between axle of rear wheels is 300 mm and the distance between a back wheel of front wheels and a front wheel of back wheels is 290 mm.

Here, we can see the wheels of a running apparatus travelling on the stairs can go almost straight, not up or down. The first levers(4) can be parallel to an angle of inclination of stairs by the axis operation of the second levers(5,6) between wheels on the ground and wheels on stairs, the shock delivered from the wheels on the stairs to running apparatus is minimized.

To convert direction to go while travelling, first move the rack(11) connected to hydraulic device and moveable up or down, the pinion fixed on the second levers(5) of the front wheels gear connects and turns, and the second levers(5) angle operates on its axis. When the second levers(5) turns about 90°, one of two wheels(3) axis installed at the edges of the second levers of front wheels touches the ground. At this point, the driver converts the steering wheel right or left, then the knuckle(13) connected to a connection lever angle operates on the holder frames with pin as a starting point and it and converts, so it goes to the direction where the driver wants to go.

The wheels(3) touching the ground is connected to a joint(18), so the power is always delivered at any angles. Accordingly power can be delivered through gearing device.

When a driver wants to use only four wheels out of eight wheels, move rack(11) down to turn a pinion(10) and the second levers(6) turns about 90° then rear wheels finally touches with only one wheel touching the ground. Rear wheels(3) turns in the direction which front wheels converts, so the running apparatus can travel to the direction the driver wants to go.

The invention, the running apparatus(1) needs to go through narrow places, stairs, off roads, this running apparatus can be smaller in length and width. When travelling at high speed, for the safety, the most desirable shape is to be as big as possible in length and width. Then a driver lifts the running apparatus by lift installed under the transport to a certain height. Then use the frist levers(4) as length control device and make the length to the maximum. And make the width of running apparatus to the maximum, and move it down in order the wheels can touch the ground and then a driver can drive it.

If the driver of this running apparatus wants to travel on sands, marshy roads, rocks, or off roads instead of normal road, asphalt road, cement road, or walkway.

The driver can replace wheels with wide wheels(3a) or caterpillar of tank or can attach additionally.

Especially, this invention already put attachable devices on the wheels(22), the crippled driver can attach various wheels(3a, 3b) easily.

Wheels (3b) of caterpillar type are connected to balls(30) flexible supported by springs and installed to axis operate with pins(27) as a starting point. Therefore caterpillars(26) can strongly grip grounds not to be slipped and can solve the problem of wheels' turning on the same spot.

What is claimed is:

1. Designing the running apparatus installed in the transport which can travel stairs, ramps, and off roads:
the first levers(4) installed in the center of transport to be axis(4a) operated,
the second levers(5,6) axis installed at the edges of the first lever(4) to be angle operated,
wheels (3, 3b) installed at the edges of the second levers and connected to gearing device,
The second levers(5,6) where pinion(10) fixed, rack guide(12) on the holder frame(14) where axis connected to generator and optionally connects to rack(11) and axis operates,
Running apparatus characterizing that a drive can convert directions: The axis(7) where the second levers axis installed, is set on the center of joint(18), and installed to be axis operated with pin(15) on the holder frame(14).

2. The running apparatus characterizing that this has a lifter and control device changes the length and width of transport.

3. The running apparatus characterizing that wheels have attachment device(23) so that anybody can attach wide wheels(3a) additionally.

4. Wheels (3b) of caterpillar type are connected to balls(30) flexible supported by springs and installed to axis operate with pins(27) as a starting point. Therefore caterpillars(26) can do flexible axis operation.
